(19) United States
(12) Patent Application Publication
(10) Pub. No.: US 2023/0403624 A1
(43) Pub. Date: Dec. 14, 2023

(54) WIRELESS COMMUNICATION DEVICE, WIRELESS COMMUNICATION SYSTEM, AND TRANSMISSION METHOD

(71) Applicant: FUJITSU LIMITED, Kanagawa (JP)

(72) Inventors: Yoshiaki OHTA, Yokohama (JP); YOSHIHIRO KAWASAKI, Kawasaki (JP); Tetsuya YANO, Yokohama (JP)

(73) Assignee: FUJITSU LIMITED, Kanagawa (JP)

(21) Appl. No.: 18/237,477

(22) Filed: Aug. 24, 2023

Related U.S. Application Data
(63) Continuation of application No. PCT/JP21/09926, filed on Mar. 11, 2021.

(51) Int. Cl. H04W 40/12

(52) U.S. Cl. CPC H04W 40/12

(57) ABSTRACT

A wireless communication device includes a controller configured to configure an entity that processes data to be transmitted by a radio bearer, configure a plurality of communication channels with different communication configurations for requirements of the data, select one communication channel from the communication channels in accordance with a state of the data, and control data communication with a counterpart wireless communication device.

### CROSS-REFERENCE TO RELATED APPLICATION

This application is a continuation of International Application No. PCT/JP2021/009926, filed on Mar. 11, 2021, the entire contents of which are incorporated herein by reference.

### FIELD

The embodiments discussed herein are related to a wireless communication device, a wireless communication system, and a transmission method.

### BACKGROUND

In the field of communications, complying with the arrival time at which transmitted data arrives at a reception side in accordance with the requirements of the application may be demanded.

One example is arrival time guaranteed communication. The arrival time guaranteed communication is used in holographic communication that projects three-dimensional images or the like, and for example, may define the data arrival time by the following three methods. A first method is a method of making the data arrive by a defined time, in which the maximum value of the time until the data arrives at the reception side is specified. A second method is a method of making the data arrive within the range of a defined time, in which the minimum value and the maximum value of the time until the data arrives at the reception side are specified. A third method is a method of making a plurality of pieces of data arrive substantially simultaneously within the range of a defined time, in which the dispersion of times at which the pieces of data arrive at the reception side is specified.

For example, time-sensitive communication (TSC) is discussed in 3GPP. Survival time is defined as a “grace time” for the arrival time of transmitted data, and if the transmitted data arrives within the grace time, it can be guaranteed that the application works properly. The related technologies are described, for example, in: International Publication Pamphlet No. WO 2020/003539; and International Publication Pamphlet No. WO2018/070465 and in the following non-patent documents:
3GPP TS 36.133 V16.7.0 (2020 September);
3GPP TS 36.211 V16.4.0 (2020 December);
3GPP TS 36.212 V16.4.0 (2020 December);
3GPP TS 36.213 V16.4.0 (2020 December);
3GPP TS 36.214 V16.1.0 (2020 June);
3GPP TS 36.300 V16.4.0 (2020 December);
3GPP TS 36.321 V16.3.0 (2020 December);
3GPP TS 36.322 V16.0.0 (2020 July);
3GPP TS 36.323 V16.3.0 (2020 December);
3GPP TS 36.331 V16.3.0 (2020 December);
3GPP TS 36.413 V16.4.0 (2020 December);
3GPP TS 36.423 V16.4.0 (2020 December);
3GPP TS 36.425 V16.0.0 (2020 July);
3GPP TS 37.324 V16.2.0 (2020 September);
3GPP TS 37.340 V16.4.0 (2020 December);
3GPP TS 38.201 V16.0.0 (2019 December);
3GPP TS 38.202 V16.2.0 (2020 September);
3GPP TS 38.211 V16.4.0 (2020 December);
3GPP TS 38.212 V16.4.0 (2020 December);
3GPP TS 38.213 V16.4.0 (2020 December);
3GPP TS 38.214 V16.4.0 (2020 December);
3GPP TS 38.215 V16.4.0 (2020 December);
3GPP TS 38.300 V16.4.0 (2020 December);
3GPP TS 38.321 V16.3.0 (2020 December);
3GPP TS 38.322 V16.2.0 (2020 December);
3GPP TS 38.323 V16.2.0 (2020 September);
3GPP TS 38.331 V16.3.1 (2020 December);
3GPP TS 38.401 V16.4.0 (2020 December);
3GPP TS 38.410 V16.3.0 (2020 September);
3GPP TS 38.413 V16.4.0 (2020 December);
3GPP TS 38.420 V16.0.0 (2020 July);
3GPP TS 38.423 V16.4.0 (2021 January);
3GPP TS 38.470 V16.3.0 (2020 September);
3GPP TS 38.473 V16.4.0 (2021 January);
3GPP TR 38.801 V14.0.0 (2017 March);
3GPP TR 38.802 V14.2.0 (2017 September);
3GPP TR 38.803 V14.2.0 (2017 September);
3GPP TR 38.804 V14.0.0 (2017 March);
3GPP TR 38.900 V15.0.0 (2018 June);
3GPP TR 38.912 V15.0.0 (2018 June);
3GPP TR 38.913 V15.0.0 (2018 June);
3GPP TR 23.734 V16.2.0 (2019 June); and
3GPP TS 22.104 V17.4.0 (2020 September).

### SUMMARY

According to an aspect of an embodiment, a wireless communication device includes a controller configured to configure an entity that processes data to be transmitted by a radio bearer, configure a plurality of communication channels with different communication configurations for requirements of the data, select one communication channel from the communication channels in accordance with a state of the data, and control data communication with a counterpart wireless communication device.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a block diagram illustrating a structure of a base station device according to a first embodiment;

FIG. 2 is a block diagram illustrating a structure of a processor according to the first embodiment;

FIG. 3 is a block diagram illustrating a structure of a terminal device according to the first embodiment;

FIG. 4 is a diagram for describing a transmission method according to the first embodiment;

FIG. 5 is a block diagram illustrating a structure of a processor according to a second embodiment;

FIG. 6 is a diagram for describing a transmission method according to the second embodiment;

FIG. 7 is a diagram illustrating a specific example of assigning transmission data;

FIG. 8 is a diagram for describing another transmission method according to the second embodiment;

FIG. 9 is a diagram for describing a transmission method according to a third embodiment; and

FIG. 10 is a diagram illustrating a modification of the structure of the base station device.

### DESCRIPTION OF EMBODIMENT

However, the fifth-generation mobile communications (5G or new radio (NR)), which have been put into practical use in recent years, have the problem that it is difficult to control the arrival time of transmitted data at the reception side with fine granularity. Specifically, there is not much support for time limits on data transmission; therefore, it is not easy to flexibly control the time at which the data arrives at the reception side, making scheduling to comply with the data arrival time difficult.

Preferred embodiments will be explained with reference to accompanying drawings. The present disclosure is not limited by the embodiments below.

### (a) First Embodiment

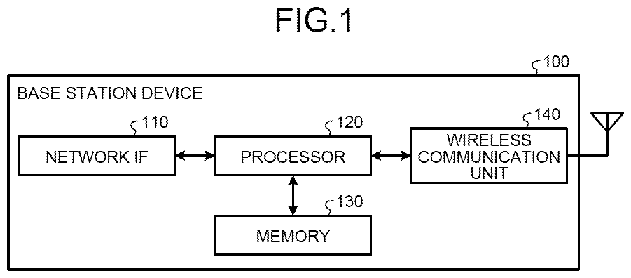

FIG. 1 is a block diagram illustrating a structure of a base station device 100 according to a first embodiment. The base station device 100 is an example of a wireless communication device. The base station device 100 illustrated in FIG. 1 includes a network interface (hereinafter abbreviated as “network IF”) 110, a processor 120, a memory 130, and a wireless communication unit 140.

The network IF 110 is connected to a core network, which is not illustrated, with a wire and transmits and receives signals to and from devices included in the core network.

The processor 120 is a control unit that includes, for example, a central processing unit (CPU), a field programmable gate array (FPGA), or a digital signal processor (DSP), and that collectively controls the entire base station device 100. The processor 120 also performs a process of a predetermined communication protocol relevant to a radio bearer for the data transmitted wirelessly. Here, the processor 120 configures a plurality of communication channels with different communication configurations, for example, the maximum time allowed before transmission in accordance with the requirements of the data. The processor 120 then selects the communication channel according to the state of the transmission data, for example, the delay time allowed for each transmission data and the number of times of transmissions (first transmission or retransmission) for each transmission data, and transmits the data using the selected communication channel.

The memory 130 includes, for example, a random access memory (RAM) or a read only memory (ROM) and stores information used for processing by the processor 120 therein.

The wireless communication unit 140 performs wireless communication with the terminal device, which is a counterpart wireless communication device. The wireless communication unit 140 transmits the transmission data that has been subjected to a process of each communication protocol in the processor 120 to the terminal device, which is the counterpart wireless communication device. In addition, the wireless communication unit 140 transmits configuration information about the data transmission of the terminal device, which is the counterpart wireless communication device, to this terminal device. The wireless communication unit 140 then receives the data that the terminal device transmits wirelessly according to the configuration information.

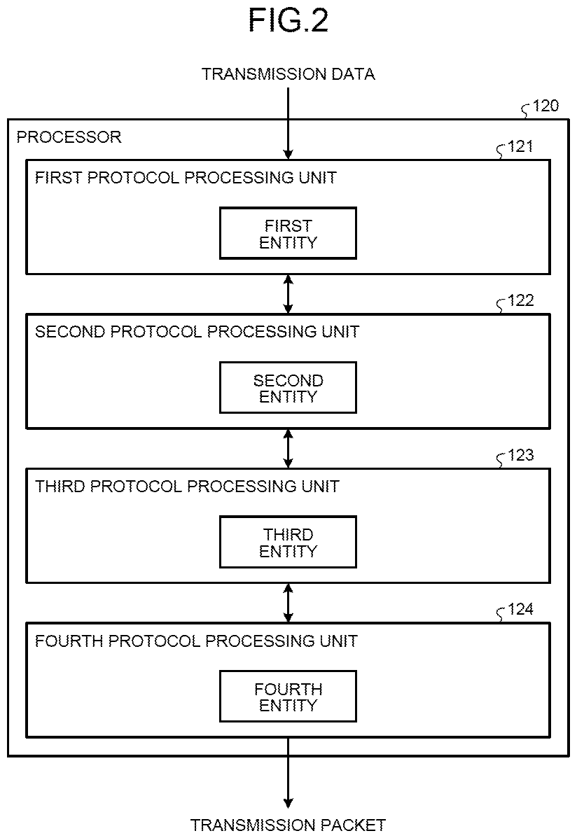

FIG. 2 is a block diagram illustrating a structure of the processor 120 according to the first embodiment. The processor 120 illustrated in FIG. 2 includes a first protocol processing unit 121, a second protocol processing unit 122, a third protocol processing unit 123, and a fourth protocol processing unit 124.

The first protocol processing unit 121 configures a first entity corresponding to an entity of a first protocol for each radio bearer, and performs a process of the first protocol for the transmission data using the first entity.

The second protocol processing unit 122 configures a second entity corresponding to an entity of a second protocol for each radio bearer, and performs, by using the second entity, a process of the second protocol for the transmission data having been subjected to the process of the first protocol. The second entity configured by the second protocol processing unit 122 selects one communication channel from the communication channels that is associated with a third entity in the third protocol processing unit 123, for example, according to the requirements of the transmission data.

The third protocol processing unit 123 configures the third entity corresponding to an entity of a third protocol for each radio bearer, and performs, by using the third entity, a process of the third protocol for the transmission data that has been subjected to the process of the second protocol. The third entity configured by the third protocol processing unit 123 with which the communication channels with the different communication configurations are associated, and the third entity assigns the transmission data to the communication channel that is selected by the second entity.

The fourth protocol processing unit 124 configures a fourth entity corresponding to an entity of a fourth protocol for each radio bearer, and performs, by using the fourth entity, a process of the fourth protocol for the transmission data that has been subjected to the process of the third protocol. The fourth entity configured by the fourth protocol processing unit 124 outputs a transmission packet, which is obtained through the process of the fourth protocol, to the wireless communication unit 140 to perform wireless transmission.

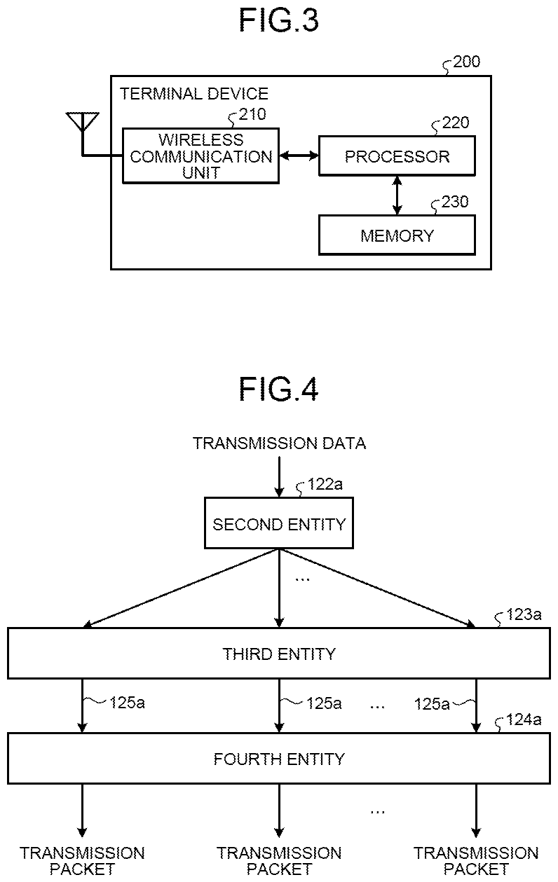

FIG. 3 is a block diagram illustrating a structure of a terminal device 200 that is a counterpart of the base station device 100. The terminal device 200 is an example of a wireless communication device. The terminal device 200 illustrated in FIG. 3 includes a wireless communication unit 210, a processor 220, and a memory 230.

The wireless communication unit 210 performs wireless communication with the base station device 100, which is the counterpart wireless communication device. The wireless communication unit 210 receives configuration information about the data transmission from the base station device 100, which is the counterpart wireless communication device. The wireless communication unit 210 then transmits the transmission data, which has been subjected to the processes of the respective communication protocols in accordance with the configuration information in the processor 220, to the base station device 100, which is the counterpart wireless communication device.

The processor 220 is a control unit that includes, for example, a CPU, an FPGA, or a DSP, and that collectively controls the entire terminal device 200. The processor 220 also performs a process of a predetermined communication protocol relevant to a radio bearer for the data transmitted wirelessly. The processor 220 of the terminal device 200 can perform the control similar to that of the processor 120 of the base station device 100. In other words, the processor 220 configures a plurality of communication channels with different communication configurations in accordance with the requirements of the data. The processor 220 then selects the communication channel in accordance with the state of the transmission data, and transmits the data using the selected communication channel.

The above communication configuration is, for example, parameters related to communication requirements, such as the maximum time allowed before transmission, priority, and subcarrier spacing (or numerology). The communication configuration can be determined for each communication channel. The state of the transmission data described above is parameters related to communication quality, such as the delay time allowed for each transmission data, priority, jitter, and the number of times of transmissions (initial transmission or retransmission) for each transmission data, for example.

The memory 230 includes, for example, a RAM or a ROM and stores information used for the process by the processor 220 therein.

Next, a transmission method for each radio bearer in the first embodiment is described with reference to FIG. 4. The transmission method described below is performed by the base station device 100 illustrated in FIG. 1 or the terminal device 200 illustrated in FIG. 3.

In this embodiment, once the radio bearer is established, the first entity of the first protocol, the second entity of the second protocol, the third entity of the third protocol, and the fourth entity of the fourth protocol for the radio bearer are configured by the processor 120 (or processor 220). In FIG. 4, a second entity 122a, a third entity 123a, and a fourth entity 124a are illustrated. To the third entity 123a, a plurality of communication channels 125a with the different communication configurations are associated, such as the maximum time allowed before transmission.

The transmission data that has been subjected to the process of the first protocol using the first entity is assigned by the second entity 122a to any of the communication channels 125a. In other words, the second entity 122a selects one communication channel 125a from the communication channels 125a according to the state of the transmission data, for example, the delay time allowed for each transmission data and the number of times of transmissions (initial transmission or retransmission) for each transmission data. At this time, the second entity 122a selects the communication channel 125a suitable for the state of the transmission data, and notifies the selected communication channel 125a to the third entity 123a.

Then, the transmission data, after being subjected to the process of the third protocol using the third entity 123a is assigned to the communication channel 125a selected by the second entity 122a and sent to the fourth entity 124a. Then, a transmission packet is generated by the process of the fourth protocol using the fourth entity 124a, and the transmission packet is transmitted wirelessly from the wireless communication unit 140 (or wireless communication unit 210).

Thus, the communication channel that is associated with the third entity is selected according to the state of the transmission data, and the data is transmitted by the communication channel with the communication configuration suitable for the requirements of the data; accordingly, the data arrival time at the reception side can be flexibly controlled, for example.

Thus, according to this embodiment, the communication channels with the different communication configurations for the requirements of the data to be transmitted by the radio bearer are configured, and the communication channel is selected in accordance with the state of the data, and the data communication is performed. Therefore, the data can be transmitted using the communication channel suitable for the state of the transmission data, for example, the delay time allowed for each transmission data and the number of times of transmissions (first transmission or retransmission) for each transmission data, and the data arrival time can be flexibly controlled.

In the related layer configuration, since the communication protocol that belongs to the layer 2 is rigidly configured, and one radio bearer is associated with one set of protocol stacks, it has been difficult to flexibly control to ensure the data arrival time. The layer configuration in this embodiment has the special effect of facilitating flexible control to guarantee the data arrival time because a plurality of sets of communication channels accompany one radio bearer is associated with a plurality of sets of communication channels.

The protocol stack in this embodiment is applicable to both unidirectional and bidirectional communications, regardless of whether the communication is for uplink or downlink.

### (b) Second Embodiment

The structure of the base station device and the terminal device according to a second embodiment is similar to that of the base station device 100 and the terminal device 200 according to the first embodiment; thus, the description thereof is omitted. The second embodiment is also one specific embodiment of the first embodiment. In the second embodiment, the structure of the processor 120 (or processor 220) is more detailed than that in the first embodiment.

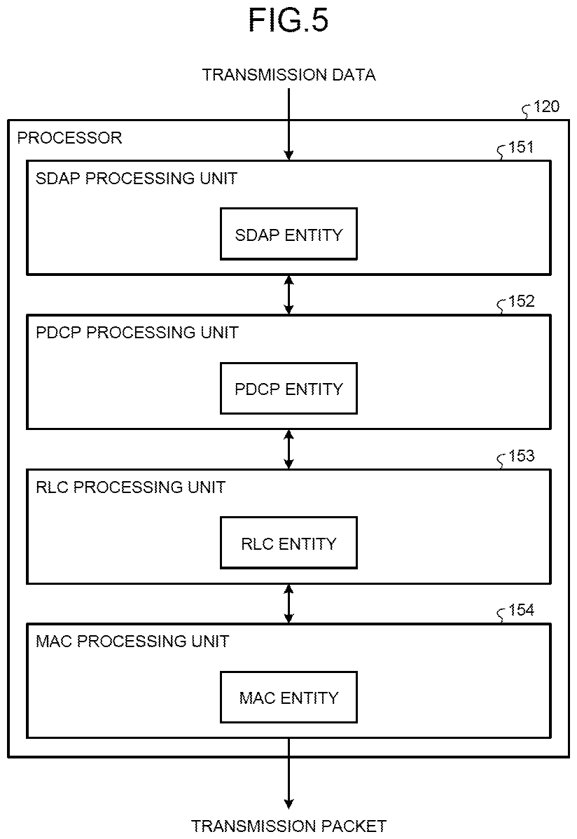

FIG. 5 is a block diagram illustrating a structure of the processor 120 according to the second embodiment. The processor 220 of the terminal device 200 also employs the structure similar to that of the processor 120 illustrated in FIG. 5. The processor 120 illustrated in FIG. 5 includes a service data adaptation protocol (SDAP) processing unit 151, a packet data convergence protocol (PDCP) processing unit 152, a radio link control (RLC) processing unit 153, and a medium access control (MAC) processing unit 154.

The SDAP processing unit 151 configures an SDAP entity, which is an entity of an SDAP layer for each radio bearer, and performs a process of the SDAP layer for the transmission data using the SDAP entity.

The PDCP processing unit 152 configures a PDCP entity, which is an entity of a PDCP layer for each radio bearer, and performs, by using the PDCP entity, a process of the PDCP layer for the transmission data having been subjected to the process of the SDAP layer. The PDCP entity configured by the PDCP processing unit 152 selects one logical channel (LCH) from among a plurality of LCHs that is associated with an RLC entity in the RLC processing unit 153, for example, according to the requirements of the transmission data.

The RLC processing unit 153 configures the RLC entity, which is an entity of a RLC layer for each radio bearer, and performs, by using the RLC entity, a process of the RLC layer for the transmission data having been subjected to the process of the PDCP layer. To the RLC entity configured by the RLC processing unit 153, the LCHs with different communication configurations are associated, and the RLC entity assigns the transmission data to the LCH selected by the PDCP entity.

The MAC processing unit 154 configures a MAC entity, which is an entity of a MAC layer for each radio bearer, and performs, by using the MAC entity, a process of the MAC layer for the transmission data having been subjected to the process of the RLC layer. The MAC entity configured by the MAC processing unit 154 outputs a transmission packet obtained by the process of the MAC layer to the wireless communication unit 140 and performs wireless transmission.

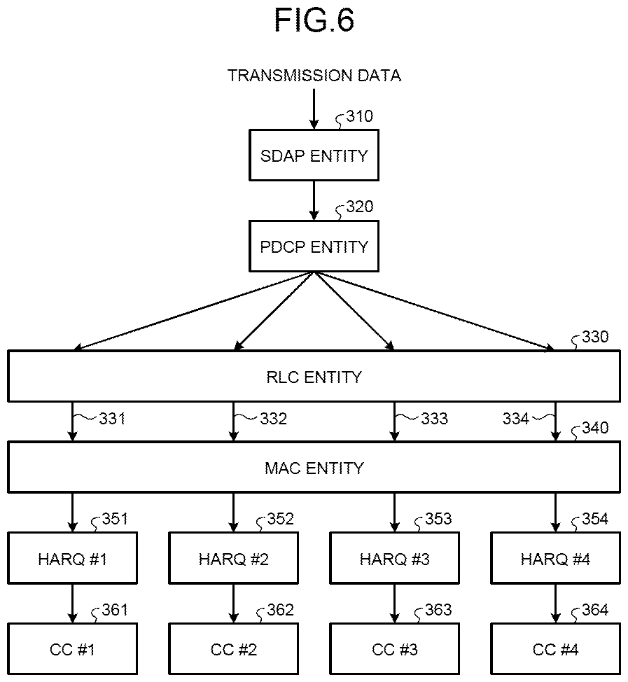

Next, a transmission method for each radio bearer in the second embodiment is described with reference to FIG. 6. The transmission method described below is performed by the base station device 100 illustrated in FIG. 1 or the terminal device 200 illustrated in FIG. 3.

In this embodiment, once a radio bearer is established, the SDAP entity, the PDCP entity, the RLC entity, and the MAC entity for the radio bearer are configured by the processor 120 (or processor 220). FIG. 6 illustrates an SDAP entity 310, a PDCP entity 320, an RLC entity 330, and a MAC entity 340. To the RLC entity 330, LCHs 331 to 334 with different communication configurations are associated, and HARQs 351 to 354 and component carriers (CCs) 361 to 364 correspond to the respective LCHs 331 to 334.

The transmission data is subjected to the process of the SDAP layer using the SDAP entity 310 and sent to the PDCP entity 320. The transmission data is then subjected to the process of the PDCP layer using the PDCP entity 320, and is also assigned to any of the four LCHs 331 to 334. For example, the PDCP entity 320 selects the LCHs 331 to 334 to which the transmission data is assigned, according to the time at which the transmission data arrives at the PDCP entity 320 and the delay time allowed for each transmission data. The PDCP entity 320 may select the LCHs 331 to 334 to which the transmission data is assigned depending on whether, for example, the transmission data is data to be transmitted for the first time or data to be retransmitted. For example, the LCH can also be selected by the method disclosed in the first embodiment described above.

The transmission data is the data transmitted by one radio bearer; however, the time at which the transmission data arrives at the PDCP entity 320 varies in units of packets due to the variation in processing time in the application layer, variation in transmission delay from a core network (jitter or burst spread), or the like. In addition, if a radio transmission error occurs for the transmission data, retransmission is performed, which causes a delay. The retransmission is equivalent to the variation in arrival time for the PDCP entity 320. Therefore, the PDCP entity 320 assigns the transmission data to the LCHs 331 to 334 in units of packets. In other words, when controlling the data arrival time at the reception side, the LCHs 331 to 334 suitable for the delay time of each packet are selected because the delay time allowed for a packet, for example, the packet delay budget (PDB), varies depending on the time of arrival at the PDCP entity 320.

For example, in the terminal device 200, maxPUSCH-Durations with different values are configured to the four LCHs 331 to 334. The maxPUSCH-Duration is a parameter indicating the maximum time allowed before the data is transmitted. Here, it is assumed that large-to-small values of maxPUSCH-Duration are configured to the LCHs 331, 332, 333, and 334 in this order. The PDCP entity 320, for example, selects the LCH 331 with the largest maxPUSCH-Duration for the packet whose arrival time is early, selects the LCH 332 with the second largest maxPUSCH-Duration for the packet whose arrival time is an appointed time, selects the LCH 333 with the third largest maxPUSCH-Duration for the packet whose arrival time is delayed, and selects the LCH 334 with the fourth largest maxPUSCH-Duration for the packet whose arrival time is about to expire. The PDCP entity 320 then notifies the selected LCHs 331 to 334 to the RLC entity 330.

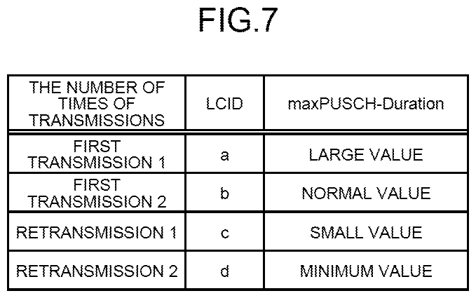

The PDCP entity 320 may select the LCHs 331 to 334 depending on whether the transmission data is an initial transmission packet or a retransmission packet. For example, the correspondence between the number of times of transmissions of the packet and the LCH to be selected is as illustrated in FIG. 7. As illustrated in FIG. 7, the four LCHs 331 to 334 are assigned LCIDs, which are the identifying information that identifies the respective LCHs 331 to 334. Here, it is assumed that LCID “a” is assigned to the LCH 331, LCID “b” to the LCH 332, LCID “c” to the LCH 333, and LCID “d” to the LCH 334. Then, the maxPUSCH-Duration of the LCH 331 with LCID “a” is a large value, the maxPUSCH-Duration of the LCH 332 with LCID “b” is a normal value, the maxPUSCH-Duration of the LCH 333 with LCID “c” is a small value, and the maxPUSCH-Duration of the LCH 334 with LCID “d” is the minimum value. Thus, in the terminal device 200, maxPUSCH-Durations, for example, are different as the communication configurations of the communication channels.

The PDCP entity 320, for example, selects the LCH 331 or 332 with LCID “a” or “b” for the first-transmission packet and selects the LCH 333 or 334 with LCID “c” or “d” for the retransmitted packet. The PDCP entity 320 then notifies the selected LCHs 331 to 334 to the RLC entity 330.

The packets can be assigned to the respective LCHs 331 to 334 by using the splitting function and the routing function of the PDCP layer. In other words, in the base station device 100, the packets can be assigned to the LCHs 331 to 334 using the splitting function of the PDCP layer, for example, to assign the packets to other base station device when multiple connections are performed. In the terminal device 200, for example, the packets can be assigned to the LCHs 331 to 334 using the routing function of the PDCP layer to assign the packets to a plurality of cells when multiple connections are performed. The assignment of the packets to the LCHs 331 to 334 does not have to be performed at the PDCP layer, but may be alternatively performed in the SDAP layer, for example.

The transmission data assigned to the LCHs 331 to 334, after being subjected to the process of the RLC layer using the RLC entity 330, assigned to the respective LCHs 331 to 334, and then sent to the MAC entity 340. Then, by the process of the MAC layer using the MAC entity 340, the transmission packet is generated. The transmission packet is subjected to the configuration of retransmission in accordance with the HARQs 351 to 354 relevant to the LCHs 331 to 334, and is transmitted wirelessly from the wireless communication unit 140 (or wireless communication unit 210) by the CCs 361 to 364 relevant to the LCHs 331 to 334.

The configurations of retransmission in the HARQs 351 to 354 may be different for the corresponding LCHs 331 to 334. For example, in the HARQ 351 of the LCH 331 to which the packet whose arrival time is early is assigned, it is configured so that the retransmission process is performed using ACK and NACK because there is enough time; on the other hand, in the HARQ 354 of the LCH 334 to which the packet whose arrival time is about to expire is assigned, it is configured so that the retransmission process is not performed and the radio resource may be given to another traffic because there is not enough time. Because of different radio qualities, the CCs 361 to 364 may correspond to the respective LCHs 331 to 334 according to the radio quality. For example, the CC 361 with relatively low radio quality may correspond to the LCH 331 to which the packet whose arrival time is early is assigned, while the CC 364 with relatively high radio quality may correspond to the LCH 334 to which the packet whose arrival time is about to expire is assigned. Furthermore, the CCs that are expected to transmit with smaller delay may correspond to the LCHs to which the packets whose arrival time is later are assigned. In this case, for example, the CC 364 in the millimeter wave band may correspond to the LCH 334 to which the packet whose arrival time is about to expire is assigned.

In this way, the LCH that is associated with the RLC entity is selected according to the state of the transmission data, such as the allowable delay time, and the data is transmitted by the LCH with the communication configuration suitable for the data requirements; thus, the data arrival time at the reception side, for example, can be flexibly controlled.

As described above, according to this embodiment, the LCHs with different communication configurations corresponding to the requirements of the data to be transmitted by the radio bearer are configured, the LCHs is selected in accordance with the state of the data, and the data communication is performed. Therefore, the data can be transmitted using the LCH suitable for the state of the transmission data, for example, the delay time allowed for each transmission data, and the data arrival time can be flexibly controlled.

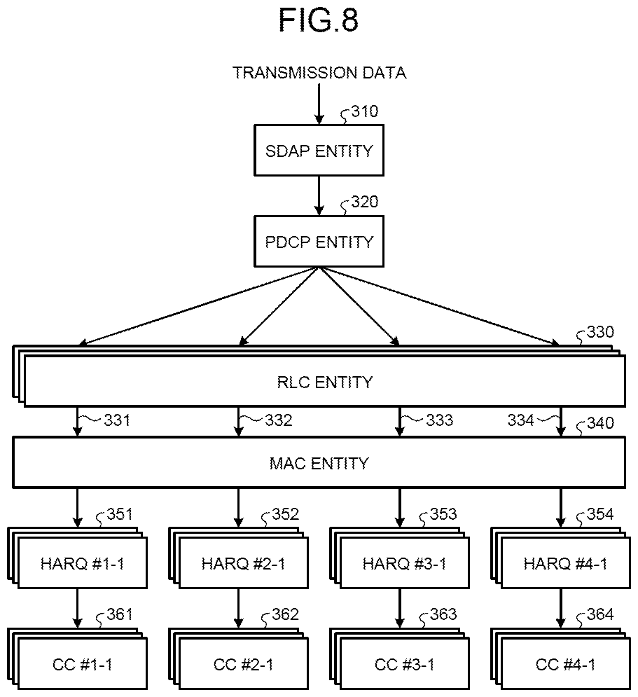

In addition, PDCP duplication, which duplicates the packet in the PDCP layer, may be used in combination. In this case, for example, as illustrated in FIG. 8, the RLC entity 330 and the LCHs 331 to 334 are added in accordance with the packets to be duplicated. In other words, the RLC entities 330 are configured in accordance with the packets to be duplicated, and the HARQs 351 to 354 and the CCs 361 to 364 corresponding to the LCHs 331 to 334 are set. Thus, the duplicated packets are transmitted in the different radio environments and the reliability can be improved.

### (c) Third Embodiment

The structure of the base station device and the terminal device according to a third embodiment is similar to that of the base station device 100 and the terminal device 200 according to the first embodiment; thus, the description thereof is omitted. The structure of the processor in the third embodiment is similar to that of the processor 120 in the second embodiment; thus, the description thereof is omitted. In the third embodiment, the assignment of the CC to the packet is different from that in the first and the second embodiments. The third embodiment is also one specific embodiment of the first embodiment.

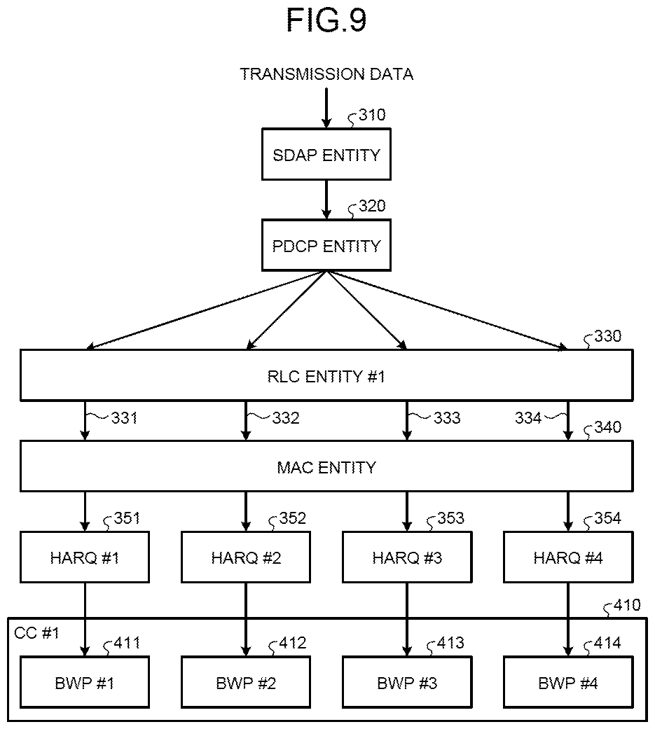

FIG. 9 is a diagram illustrating a transmission method for each radio bearer in the third embodiment. In FIG. 9, the same parts as those in FIG. 6 are denoted by the same symbols.

In this embodiment, similarly to the second embodiment, once a radio bearer is established, the SDAP entity, the PDCP entity, the RLC entity, and the MAC entity for the radio bearer are configured by the processor 120 (or processor 220). FIG. 9 illustrates an SDAP entity 310, a PDCP entity 320, an RLC entity 330, and a MAC entity 340. To the RLC entity 330, the LCHs 331 to 334 with different communication configurations are associated, and the HARQs 351 to 354 and bandwidth parts (BWPs) 411 to 414 of a CC 410 correspond to the respective LCHs 331 to 334.

The transmission data is subjected to the process of the SDAP layer using the SDAP entity 310 and sent to the PDCP entity 320. The transmission data is then subjected to the process of the PDCP layer using the PDCP entity 320, and is also assigned to any of the four LCHs 331 to 334 that is associated with the RLC entity 330. For example, the PDCP entity 320 selects the LCHs 331 to 334 to which the transmission data is assigned, according to the time at which the transmission data arrives at the PDCP entity 320 and the delay time allowed for each transmission data, and notifies the selected LCH 331 to the RLC entity 330. For example, the LCH can also be selected by the method disclosed in the first embodiment described above.

The transmission data, after being subjected to the process of the RLC layer using the RLC entity 330, assigned to the LCHs 331 to 334 notified from the PDCP entity 320, and then is sent to the MAC entity 340. Then, by the process of the MAC layer using the MAC entity 340, a transmission packet is generated. The transmission packet is subjected to the configuration of retransmission in accordance with the HARQs 351 to 354 relevant to the LCHs 331 to 334, and is transmitted wirelessly from the wireless communication unit 140 (or wireless communication unit 210) by the BWPs 411 to 414 relevant to the LCHs 331 to 334.

Because of different radio qualities, the BWPs 411 to 414 may correspond to the LCHs 331 to 314 according to the radio quality. For example, the BWP 411 with relatively low radio quality may correspond to the LCH 311 to which the packet whose arrival time is early is assigned, while the BWP 414 with relatively high radio quality may correspond to the LCH 314 to which the packet whose arrival time is about to expire is assigned. Furthermore, the subcarrier spacing (SCS) of the BWPs 411 to 414 for the respective LCHs 311 to 314 may be set differently to control the characteristics of the BWPs 411 to 414.

In this way, since the LCH that is associated with the RLC entity is selected according to the state of the transmission data, such as the allowable delay time, and the data is transmitted by the LCH with the communication configuration suitable for the data requirements, the data arrival time at the reception side, for example, can be flexibly controlled. Since the BWPs included in a single CC correspond to the respective LCHs, the number of CCs used for the data transmission can be reduced to reduce power consumption.

As described above, according to this embodiment, the LCHs with different communication configurations corresponding to the requirements of the data to be transmitted by the radio bearer are configured, and the LCHs is selected in accordance with the state of the data, and the data communication is performed. Therefore, the data can be transmitted using the LCH suitable for the state of the transmission data, for example, the delay time allowed for each transmission data, and the data arrival time can be flexibly controlled. In addition, the number of CCs used to transmit the data can be reduced to reduce power consumption because the BWP corresponds to the LCH.

In the above first to third embodiments, the transmission method in the case where the data is transmitted between the base station device 100 and the terminal device 200 is described. However, the present disclosure is also applicable when multiple connections are performed where data is transmitted between multiple base station devices and terminal devices. In view of this, the transmission method by multiple base station devices when multiple connections are performed is described. The protocol stack in each embodiment is applicable to both unidirectional and bidirectional communications, regardless of whether the communication is for uplink or downlink. Note that if the base station device and the terminal device are opposite and the functions related to the multiple connections are aggregated and implemented in one terminal device, the following operation can be described as the operation of the terminal device.

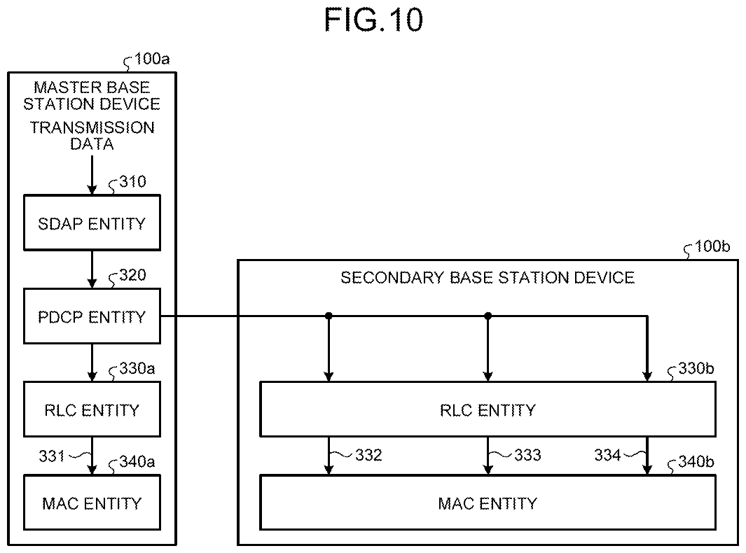

When multiple connections are performed, for example, two base station devices connect to one terminal device. At this time, a radio bearer is established that is separated into two base station devices. For example, as illustrated in FIG. 10, the radio bearer is separated into a master base station device 100a and a secondary base station device 100b. In FIG. 10, the same symbols are used for the same parts as those in FIG. 6.

Once the radio bearer is established, the SDAP entity 310, the PDCP entity 320, an RLC entity 330a, and a MAC entity 340a for the radio bearer are configured in the master base station device 100a. The radio bearer is separated in the PDCP entity 320, and an RLC entity 330b and a MAC entity 340b are configured in the secondary base station device 100b. The RLC entity 330a of the master base station device 100a is accompanied by the LCH 331, and the RLC entity 330b of the secondary base station device 100b is accompanied by the LCHs 332 to 334 whose communication configurations are different from that of the LCH 331 and are different from each other.

The transmission data is subjected to the process of the SDAP layer using the SDAP entity 310 and sent to the PDCP entity 320. The transmission data is then subjected to the process of the PDCP layer using the PDCP entity 320, and is also assigned to any of the four LCHs 331 to 334. The PDCP entity 320 selects the LCHs 331 to 334 to which the transmission data is assigned, according to the time at which the transmission data arrives at the PDCP entity 320 and the delay time allowed for each transmission data, and notifies the selected LCHs 331 to 334 to the RLC entity 330a or the RLC entity 330b with which those LCHs are associated. In this case, the LCH 331 accompanies the RLC entity 330a of the master base station device 100a while the LCHs 332 to 334 associate with the RLC entity 330b of the secondary base station device 100b; however, it is possible to assign the packets between other base station devices by using the splitting function of the PDCP layer.

The transmission data assigned to the LCHs 331 to 334, after being subjected to the process of the RLC layer using the RLC entity 330a or the RLC entity 330b, assigned to the LCHs 331 to 334 notified from the PDCP entity 320 and sent to the MAC entity 340a or the MAC entity 340b. By the process of the MAC layer using the MAC entity 340a or the MAC entity 340b, a transmission packet is generated. The transmission packet is wirelessly transmitted from the master base station device 100a or the secondary base station device 100b. That is, the data assigned to the LCH 331 is transmitted from the master base station device 100a, and the data assigned to the LCHs 332 to 334 are transmitted from the secondary base station device 100b.

In the example illustrated in FIG. 10, the LCH 331 is associated with the RLC entity 330a in the master base station device 100a and the LCHs 332 to 334 is associated with the RLC entity 330b in the secondary base station device 100b; however, the LCHs configured in each base station device are not limited to the above. That is to say, for example, the LCHs 331 and 332 may be configured in the master base station device 100a and the LCHs 333 and 334 may be configured in the secondary base station device 100b, or the LCHs 331 to 333 may be configured in the master base station device 100a and the LCH 334 may be configured in the secondary base station device 100b. In short, some of the LCHs may be configured in the master base station device 100a and the remaining LCHs may be configured in the secondary base station device 100b.

In addition, the above embodiments can be performed in combination as appropriate. For example, the PDCP duplication may be applied to the packets that are assigned to the master base station device 100a and the secondary base station device 100b, or three BWPs included in one CC may correspond to three LCHs configured in the secondary base station device 100b.

According to one aspect of the wireless communication device, the wireless communication system, and the transmission method disclosed herein, the effect is obtained in which the arrival time of data can be flexibly controlled.

All examples and conditional language recited herein are intended for pedagogical purposes of aiding the reader in understanding the disclosure and the concepts contributed by the inventors to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A wireless communication device comprising:
a controller configured to:
configure an entity that processes data to be transmitted by a radio bearer;
configure a plurality of communication channels with different communication configurations for requirements of the data;
select one communication channel from the communication channels in accordance with a state of the data; and
control data communication with a counterpart wireless communication device.

2. The wireless communication device according to claim 1, wherein the controller is further configured to:
configure a first entity performing a process of a first protocol for the data to be transmitted by the radio bearer;
configure a second entity performing a process of a second protocol for the data; and
configure a third entity performing a process of a third protocol for the data, the communication channels with different communication configurations being associated with the third entity, wherein
the second entity selects the communication channel with the communication configuration relevant to the state of the data and notifies the selected communication channel to the third entity, and
the third entity assigns the data to the communication channel notified from the second entity.

3. The wireless communication device according to claim 2, wherein the second entity selects the communication channel in accordance with a time at which the data arrives at the second entity and a delay time allowed for the data.

4. The wireless communication device according to claim 2, wherein the second entity selects the communication channel in accordance with a number of times of transmissions of the data.

5. The wireless communication device according to claim 2, wherein the first protocol is a service data adaptation protocol (SDAP).

6. The wireless communication device according to claim 2, wherein the second protocol is a packet data convergence protocol (PDCP).

7. The wireless communication device according to claim 2, wherein the third protocol is a radio link control (RLC).

8. The wireless communication device according to claim 2, wherein
the controller is further configured to configure a fourth entity performing a process of a fourth protocol for the data, and
the fourth entity configures retransmission of the data in accordance with the communication channel to which the data is assigned.

9. The wireless communication device according to claim 1, further including a wireless transmitter that transmits the data to the counterpart wireless communication device, wherein
the wireless transmitter transmits the data using a carrier wave in a frequency band relevant to the communication channel to which the data is assigned.

10. A wireless communication device comprising:
a controller configured to:
configure an entity that processes data to be transmitted by a radio bearer,
configure a plurality of communication channels with different communication configurations for requirements of the data,
select one communication channel from the communication channels in accordance with a state of the data, and
control data communication with a counterpart wireless communication device, in accordance with a control of the counterpart wireless communication device.

11. A wireless communication system comprising:
a first wireless communication device; and
a second wireless communication device that is a counterpart of the first wireless communication device, wherein
the first wireless communication device includes a controller configured to,
configure an entity that processes data to be transmitted by a radio bearer,
configure a plurality of communication channels with different communication configurations for requirements of the data,
select one communication channel from the communication channels in accordance with a state of the data, and
control data communication with the second wireless communication device.

12. A transmission method to be performed by a wireless communication device, the method comprising:
configuring an entity that performs a process of a predetermined protocol on data to be transmitted by a radio bearer;
configuring a plurality of communication channels that are associated with the entity and have different communication configurations for requirements of the data;
selecting one communication channel from the communication channels in accordance with a state of the data; and
controlling data communication with a counterpart wireless communication device using the selected communication channel.
